(19) United States
(12) Patent Application Publication
(10) Pub. No.: US 2013/0080951 A1
(43) Pub. Date: Mar. 28, 2013

(54) DEVICE AND METHOD FOR MOVING ICONS ACROSS DIFFERENT DESKTOP SCREENS AND RELATED COMPUTER READABLE STORAGE MEDIA COMPRISING COMPUTER EXECUTABLE INSTRUCTIONS

(71) Applicants: CHIA-HAO CHUANG, Tu-Cheng (TW); CHIH-SAN CHIANG, Tu-Cheng (TW); SHENG-CHU LU, Shenzhen City (CN); DA-JUN XIONG, Shenzhen City (CN); YAO-HUI ZENG, Shenzhen City (CN); YUAN-YUAN JIANG, Shenzhen City (CN)

(72) Inventors: CHIA-HAO CHUANG, Tu-Cheng (TW); CHIH-SAN CHIANG, Tu-Cheng (TW); SHENG-CHU LU, Shenzhen City (CN); DA-JUN XIONG, Shenzhen City (CN); YAO-HUI ZENG, Shenzhen City (CN); YUAN-YUAN JIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/290,021

(22) Filed: Nov. 4, 2011

(30) Foreign Application Priority Data
Sep. 26, 2011 (CN) 201110287942.9

(51) Int. Cl. G06F 3/048

(52) U.S. Cl. 715/765

(57) ABSTRACT

An electronic device with a touch screen device configured to display succeeding or preceding desktop screens. Each desktop screen includes opposite boundaries and displays icons. A touched and dragged icon may be added to any desired desktop screen. A method of moving icons and one or more computer readable storage media comprising computer executable instructions are also disclosed.

### BACKGROUND

1. Technical Field

The present disclosure relates to an electronic device with a touch screen device, a method of moving icons across different desktop screens and one or more computer readable storage media comprising computer executable instructions.

2. Description of Related Art

Many electronic devices include many icons associated with application programs. When not all the icons can be wholly displayed on one page because of a limited display area of the electronic device, the icons must be displayed on a number of pages. When there is a need to move the icon from a current desktop screen to another desktop screen, a user can drag the icon to the edge of the current desktop screen and the electronic device will automatically change the desktop currently being viewed, so that the users can find his or her destination desktop screen and put the icon in it. However the desktop screens cycle through so fast, that placing an icon in the correct destination screen is a difficult operation.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of the touch screen device of an electronic device, according to an exemplary embodiment.

FIG. 2 is a block diagram of the electronic device of FIG. 1.

FIG. 3 is similar to FIG. 1, but illustrating an icon being moved.

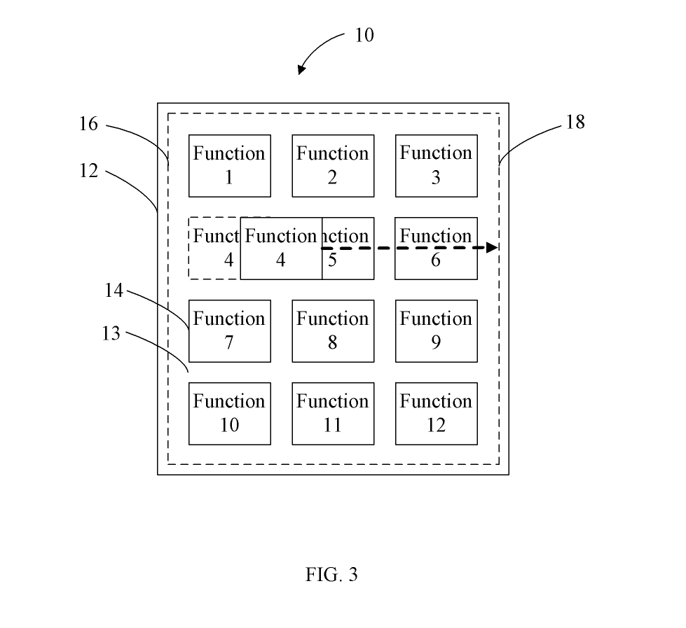

FIG. 4 is similar to FIG. 3, but illustrating the icon touched by user moved) at an edge of a current desktop screen.

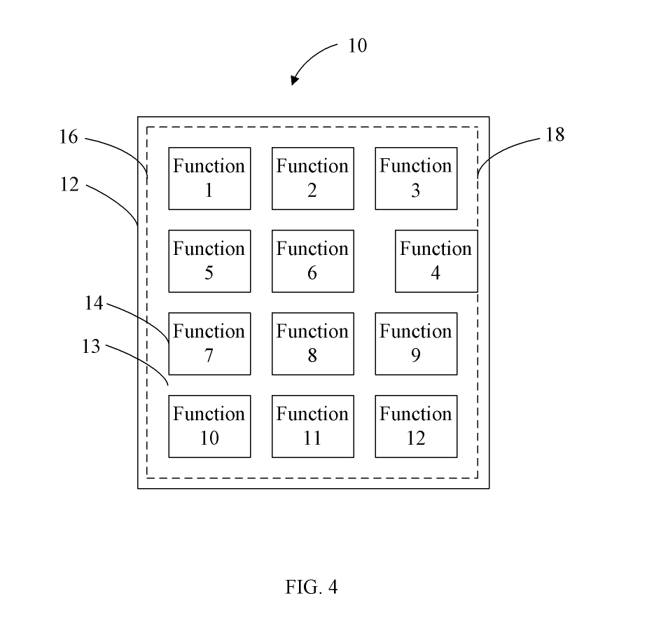

FIG. 5 is similar to FIG. 4, but illustrating the icon as moved to another desktop screen.

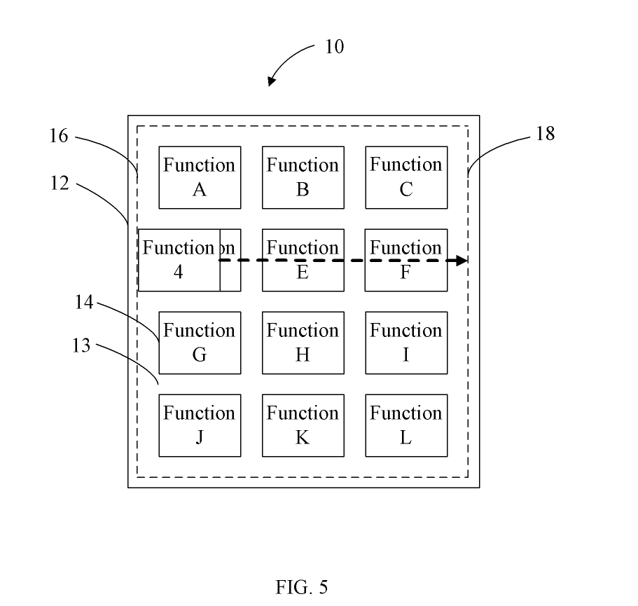

FIG. 6 is a flowchart of a method of moving icons between different desktop screens of the electronic device of FIG. 1, according to an embodiment.

FIG. 7 is a specific flowchart of the procedures S409 and S501 in the method of moving icons of FIG. 6.

### DETAILED DESCRIPTION

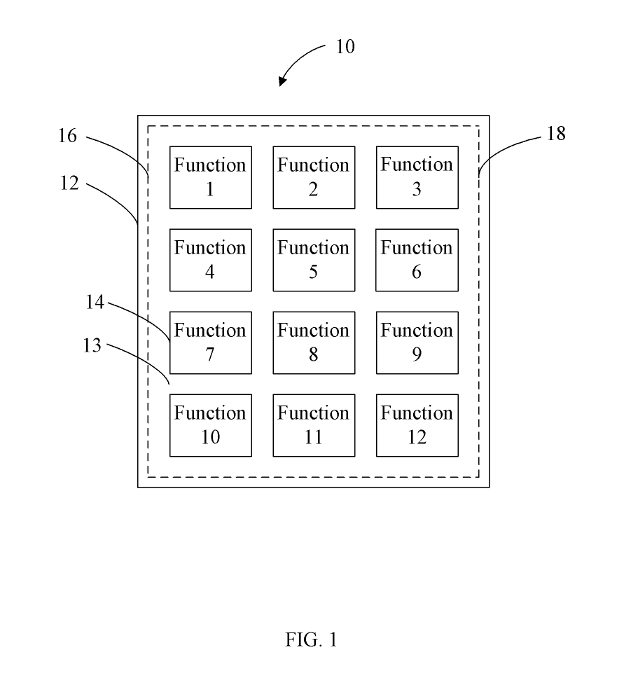

Referring to FIG. 1, an electronic device 10 according to an exemplary embodiment includes a touch screen device 12. The touch screen device 12 displays desktop screens 13, and each desktop screen 13 displays icons 14 associated with application programs. In the exemplary embodiment, when all of the icons 14 cannot be displayed on one desktop screen 13, the icons 14 can be distributed on a number of desktop screens 13. Each desktop screen 13 includes a left boundary 16 and a right boundary 18 opposite the left boundary 16.

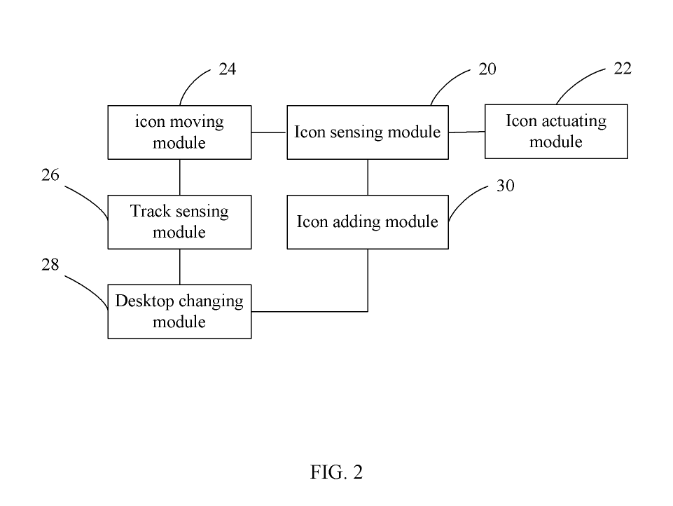

Referring to FIG. 2, the electronic device 10 includes an icon sensing module 20, an icon actuating module 22, an icon moving module 24, a track sensing module 26, a desktop changing module 28 and an icon adding module 30.

The icon sensing module 20 senses a touch on one of the icons 14 on a currently displayed desktop screen 13 by a user, and detects the duration of time of the touch on the icon 14 and determines whether the duration of time is equal to or longer than a preset time period. If the duration of time is less than the preset time period, the icon sensing module 20 determines that the touch on the icon 14 is an icon clicking operation, and in response to the icon clicking operation, the icon actuating module 22 actuates the application program associated with the icon 14. If the duration of time is equal to or longer than the preset time period, the icon sensing module 20 determines that the touch on the icon 14 is the part of an icon moving operation, and in response to the icon moving operation, the icon moving module 24 actuates the icon 14 to a movable state and further moves the icon 14 in accordance with a drag operation of the user yet to be determined in relation to the currently displayed desktop screen 13. For example, if a user then drags the icon 14 to move leftward and then releases the icon 14, then the icon 14 moves leftward automatically. If a user drags the icon 14 to move rightward and then releases the icon 14, then the icon 14 moves rightward automatically.

The track sensing module 26 is configured for sensing and determining the track or direction of movement of the icon 14. The desktop changing module 28 determines if the icon 14 reaches one of the boundaries of the currently displayed desktop screen 13. The desktop changing module 28 further changes the display of the currently displayed desktop screen 13 to an adjacent desktop screen proximate to the currently displayed desktop screen 13 if the icon 14 reaches one of the boundaries of the currently displayed desktop screen 13. Accordingly the icon moving module 24 then displays the icon 14 on the adjacent desktop screen and controls the icon 14 to be moved onto the adjacent desktop screen from out of one of the boundaries (16 or 18) to be displayed inside an opposite boundary (18 or 16 respectively), at a preset speed along a same movement direction.

For example, when the track sensing module 26 senses a rightward movement of an icon 14 and the icon 14 has reached the right hand boundary 18 of the currently displayed desktop screen 13, the desktop changing module 28 changes the display of the current desktop screen 13 to the adjacent desktop screen immediately following the currently displayed desktop screen 13. Therefore, the icon moving module 24 displays the icon 14 on the adjacent desktop screen, and begins to move the icon 14 from the entry point on the left boundary 16 towards the right boundary 18 on that next desktop screen, at a slow preset speed. When the track sensing module 26 senses a leftward movement of the icon 14 and the icon 14 has reached the left bound 16 of the currently displayed desktop screen 13, the desktop changing module 28 changes the display of the currently displayed desktop screen 13 to show the adjacent desktop screen which immediately preceding the currently displayed desktop screen 13. Accordingly the icon moving module 24 displays the icon 14 on that previous desktop screen and slowly moves the icon 14 from the right boundary 18 towards the left boundary 16 at the preset speed.

During the movement of the icon 14 at the preset speed, if the icon sensing module 20 senses another independent touch on a newly-displayed desktop screen 13 changed from the originally displayed desktop screen by the desktop changing module 28, the icon moving module 24 stops the movement of the icon 14 on the newly-displayed desktop screen 13 and the icon adding module 30 adds the icon 14 to the newly-displayed desktop screen 13. Thus, when a desired desktop screen 13 appears in the cycle, the new touch of the user on the newly-displayed desktop screen 13 will cause the icon 14 to be added to the newly-displayed desktop screen 13. If the newly-displayed desktop screen 13 is not the desired desktop screen, the electronic device 10 continues the across-screen movements until the desired desktop screen appears, then the user may touch the desired desktop screen 13, to add the icon 14 to the newly-displayed desktop screen.

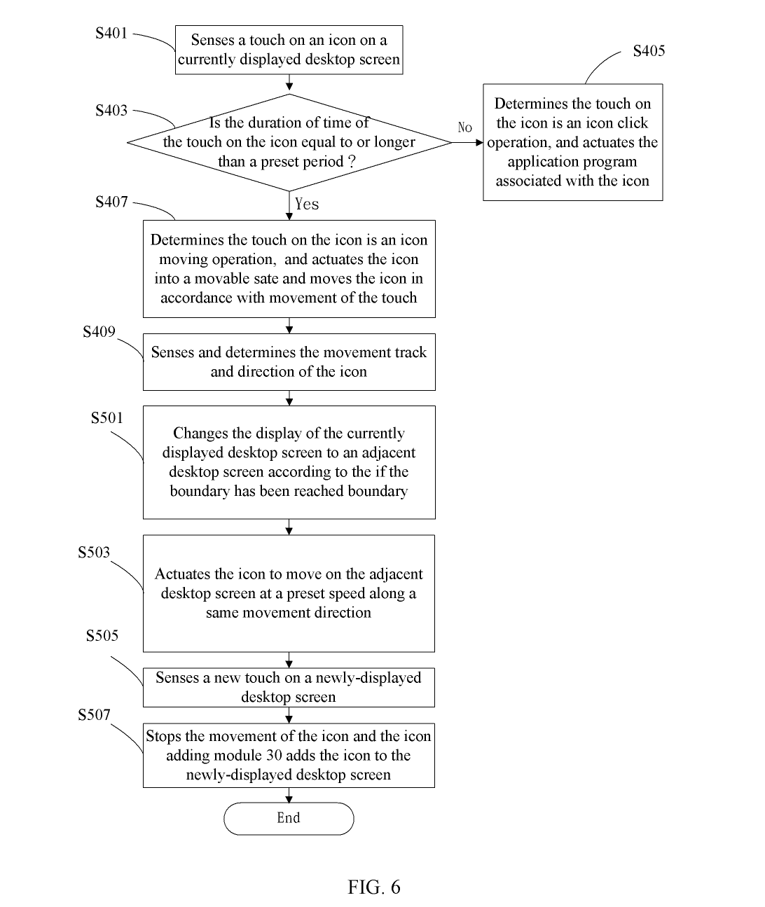

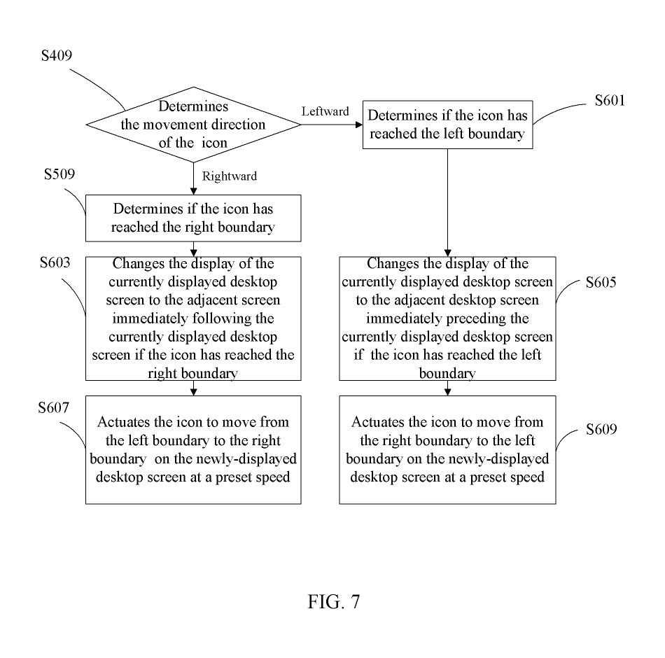

Referring to FIGS. 6 and 7, a flowchart of a method of moving an icon 14 of the electronic device 10 is provided.

In step S401, the icon sensing module 50 senses a touch on an icon 14 on a currently displayed desktop screen 13.

In step S403, the icon sensing module 20 detects the duration of time of the touch on the icon 14 and determines whether the duration of time of the touch is equal to or longer than a preset time period. If the duration of time is equal to or longer than the preset time period, the procedure goes to step S407, otherwise the procedure goes to step S405.

In step S405, the icon sensing module 20 determines that the touch on the icon 14 is an icon clicking operation, and the icon actuating module 22 actuates the application program associated with the icon 14.

In step S407, the icon sensing module 20 determines that the touch on the icon 14 is an icon moving operation, and the icon moving module 24 actuates the icon 14 into a movable state and moves the icon in accordance with the movement of the touch on the currently displayed desktop screen 13.

In step S409, the track sensing module 26 senses and determines the movement track and direction of the icon 14.

In step S501, the desktop changing module 28 changes the display of the currently displayed desktop screen 13 to an adjacent desktop screen according to the if the boundary has been reached boundary.

In step S503, the icon moving module 24 actuates the icon 14 to move on the adjacent desktop screen at a preset speed along a same movement direction.

In step S505, the icon sensing module 20 senses a new touch on a newly-displayed desktop screen 13.

In step S507, the icon moving module 24 stops the movement of the icon 14 and the icon adding module 30 adds the icon 14 to the newly-displayed desktop screen 13.

In the exemplary embodiment, the procedure S501 includes following procedure S509 to S5605, the procedure S503 includes following procedure S607 to S609.

If S509 follows step S409, the track sensing module 26 senses a rightward movement of the icon 14, and the desktop changing module 28 may determine if the icon 14 has reached the right boundary 18 of the currently displayed desktop screen 13.

If step S601 follows step S409, the track sensing module 26 senses a leftward movement of the icon 14, and the desktop changing module 28 may determine if and when the icon 14 has reached the left boundary 16 of the currently displayed desktop screen 13.

In step S603, the desktop changing module 28 changes the display of the currently displayed desktop screen 13 to the adjacent desktop screen immediately following the currently displayed desktop screen 13, when the desktop changing module 28 has determined that the icon 14 has reached the right boundary 18 of the currently displayed desktop screen 13, in step S509.

In step S605, the desktop changing module 28 changes the display of the currently displayed desktop screen 13 to the adjacent desktop screen immediately preceding the currently displayed desktop screen 13, when the desktop changing module 28 determines that the icon 14 has reached the left boundary 16 of the currently displayed desktop screen 13, in step S601.

In step S607, when the desktop changing module 28 changes the currently displayed desktop screen 13 to the next desktop screen, the icon moving module 24 actuates the icon 14 to move from the left boundary 16 to the right boundary 18 on the newly-displayed desktop screen 13 at a preset speed.

In step S609, when the desktop changing module 28 changes the currently displayed desktop screen 13 to a previous desktop screen, the icon moving module 24 actuates the icon 14 to move from the right boundary 18 to the left boundary 16 on the newly-displayed desktop screen 13 at a preset speed.

It is to be understood, however, that even though numerous characteristics and advantages of the present disclosure have been set fourth in the foregoing description, together with details of the structure and function of the present disclosure, the present disclosure is illustrative only, and changes may be made in detail, especially in that matters of shape, size, and arrangement of parts within the principles of the present disclosure to the full extent indicated by the broad general meaning of the terms in which the appended claims are expressed.

what is claimed is:

1. An electronic device, comprising:
a touch screen device configured to selectively display one of a plurality of desktop screens each time, the desktop screens configured to display icons associated with application programs, each desktop screen comprising a left boundary and a right boundary;
an icon sensing module configured to sense a touch on an icon on a currently displayed desktop screen by a user;
an icon moving module configured to actuate the icon to a movable state if the touch on the icon is determined as an icon moving operation and move the icon on the currently displayed desktop screen;
a track sensing module configured to sense a movement track of the icon on the currently displayed desktop screen and determining the movement direction of the icon;
a desktop changing module configured to change a display of the currently displayed desktop screen to an adjacent desktop screen proximate to the currently displayed desktop screen if the icon reaches a boundary of the currently displayed desktop screen, and actuate the icon moving module to further move the icon on the adjacent desktop screen along a same movement direction; and
an icon adding module configured for adding the icon to a newly-displayed desktop screen changed, by the desktop changing module, from the originally displayed desktop screen in response to a touch by a user on said newly displayed desktop screen.

2. The electronic device as described in claim 1, wherein the icon moving module is configured to move the icon on the adjacent desktop screen from one of the left and right boundaries to the other at a preset speed.

3. The electronic device as described in claim 2, wherein when the track sensing module senses a rightward movement of the icon and the icon reaches the right boundary of the current desktop screen, the desktop changing module is configured to change the currently displayed desktop screen to the adjacent desktop screen immediately following the currently displayed desktop screen, and the icon moving module is configured to display the icon on the adjacent desktop screen and moves the icon from the left boundary to the right boundary on the adjacent desktop screen.

4. The electronic device as described in claim 2, wherein when the track sensing module senses a leftward movement of the icon and the icon reaches the left boundary of the currently displayed desktop screen, the desktop changing module is configured to change the currently displayed desktop screen to the adjacent desktop screen immediately preceding the currently displayed desktop screen, and the icon moving module is configured to display the icon on the adjacent desktop screen and moves the icon from the right boundary to the left boundary on the adjacent desktop screen.

5. The electronic device as described in claim 1, wherein the icon sensing module is further configured to detect an duration of time of the touch on the icon and determines whether the duration of time of the touch on the icon is equal to or longer than a preset time period, if the duration of time is equal to or longer than the preset time period, the icon sensing module is configured to determine that the touch on the icon is an icon moving operation.

6. The electronic device as described in claim 5, further comprising an icon actuating module, if the duration of time is less than the preset time period, the icon sensing module is configured to determine that the touch on the icon is an icon clicking operation, the icon actuating module is configured to actuate the application program associated with the icon if the touch on the icon is an icon clicking operation.

7. A method of moving a icon across different desktop screens of an electronic device with a touch screen device, the touch screen device configured to selectively display one of a plurality of desktop screens each time, the desktop screens configured to display icons associated with application programs and each desktop screen comprising a left boundary and a right boundary, the method comprising:
sensing a touch on an icon on a currently displayed desktop screen;
actuating the icon to move on the currently displayed desktop screen along with movement of the touch on the currently displayed desktop screen if the touch on the icon is determined as an icon moving operation;
sensing a movement track of the icon on the currently displayed desktop screen and determining the movement direction of the icon;
determining if the touch on the icon reaches a boundary of the currently displayed desktop screen, and changing a display of the currently displayed desktop screen to an adjacent desktop screen proximate to the currently displayed desktop screen if the icon reaches a boundary of the currently displayed desktop screen;
actuating the icon to move on the adjacent desktop screen at a preset speed along a same movement direction; and
adding the icon to a newly-displayed desktop screen changed, by the desktop changing module, from the originally displayed desktop screen in response to a touch by a user on said newly displayed desktop screen.

8. The method of moving an icon as described in claim 7, wherein:
the currently displayed desktop screen is changed into the adjacent desktop screen immediately following the currently displayed desktop screen and moving the icon from the left boundary to the right boundary on the adjacent desktop screen if sensing a rightward movement of the icon and the icon reaches the right boundary on the currently displayed desktop screen.

9. The method of moving an icon as described in claim 7, wherein:
the currently displayed desktop screen is changed into the adjacent desktop screen immediately preceding the currently displayed desktop screen moving the icon from the right boundary to the left boundary on the adjacent desktop screen if sensing a leftward movement of the icon and the icon reaches the left boundary on the currently displayed desktop screen.

10. The method of moving an icon as described in claim 7, further comprising:
detecting an duration of time of the touch on the icon, wherein the touch on the icon is determined as the icon moving operation if the duration of time on the icon is equal to or longer than a preset time period.

11. The method of moving an icon as described in claim 10, further comprising:
actuating the application program associated with the icon if the duration of time on the icon is less than the preset time period.

12. One or more computer readable storage media comprising computer executable instructions to be executed in electronic device with a touch screen device, the touch screen device configured to selectively display one of a plurality of desktop screens each time, the desktop screens configured to display icons associated with application programs and each desktop screen comprising a left boundary and a right boundary, the instructions, when executed, implement a method comprising:
sensing a touch on an icon on a currently displayed desktop screen;
actuating the icon to move on the currently displayed desktop screen along with movement of the touch on the currently displayed desktop screen if the touch on the icon is determined as an icon moving operation;
sensing a movement track of the icon on the currently displayed desktop screen and determining the movement direction of the icon;
determining if the touch on the icon reaches a boundary of the currently displayed desktop screen, and changing a display of the currently displayed desktop screen to an adjacent desktop screen proximate to the currently displayed desktop screen if the icon reaches a boundary of the currently displayed desktop screen;
actuating the icon to move on the adjacent desktop screen at a preset speed along a same movement direction; and
adding the icon to a newly-displayed desktop screen changed, by the desktop changing module, from the originally displayed desktop screen in response to a touch by a user on said newly displayed desktop screen.

13. The computer readable storage media as described in claim 12, wherein the method comprises:
changing the currently displayed desktop screen to the adjacent desktop screen immediately following the currently displayed desktop screen and moving the icon from the left boundary to the right boundary on the adjacent desktop screen if sensing a rightward movement of the icon and the icon reaches the right boundary on the currently displayed desktop screen.

14. The computer readable storage media as described in claim 12, wherein the method comprises:
changing the currently displayed desktop screen to the adjacent desktop screen immediately preceding the currently displayed desktop screen moving the icon from the right boundary to the left boundary on the adjacent desktop screen if sensing a leftward movement of the icon and the icon reaches the left boundary on the currently displayed desktop screen.

15. The computer readable storage media as described in claim 12, wherein the method further comprises:
detecting an duration of time of the touch on the icon, wherein the touch on the icon is determined as the icon moving operation if the duration of time on the icon is equal to or longer than a preset time period.

16. The computer readable storage media as described in claim 15, wherein the method further comprises:
actuating the application program associated with the icon if the duration of time on the icon is less than the preset time period.
